(19) United States
(12) Patent Application Publication
(10) Pub. No.: US 2014/0222841 A1
(43) Pub. Date: Aug. 7, 2014

(54) DISPLAY METHOD, ELECTRONIC DEVICE, MULTIMEDIA SYSTEM, AND COMPUTER PROGRAM PRODUCT

(71) Applicant: Wistron Corporation, New Taipei City (TW)

(72) Inventor: Po-Hsuan Liao, New Taipei City (TW)

(73) Assignee: Wistron Corporation, New Taipei City (TW)

(21) Appl. No.: 14/024,681

(22) Filed: Sep. 12, 2013

(30) Foreign Application Priority Data
Feb. 4, 2013 (TW) 102104156

(51) Int. Cl. G06F 17/30

(52) U.S. Cl. CPC G06F 17/30058
USPC 707/755

(57) ABSTRACT

A display method, an electronic device, a multimedia system and a computer program product are provided. The display method includes steps of: searching storage positions of a plurality of multimedia files in a storage device so as to retrieve a plurality of storage path strings corresponding to the plurality of multimedia files; parsing the plurality of storage path strings and consequently retrieving at least one simplified path corresponding to the plurality of multimedia files; displaying the at least one simplified path; selecting one of the at least one simplified path according to a directory selection operation; displaying at least one multimedia file corresponding to the at least one simplified path being selected.

This application claims the benefit of Taiwan application Serial No. 102104156, filed Feb. 4, 2013, the subject matter of which is incorporated herein by reference.

### BACKGROUND OF THE INVENTION

1. Field of the Invention

The invention relates in general to a display method, an electronic device and a computer program product, and more particularly to a display method, an electronic device and a computer program product.

2. Description of the Related Art

Electronic devices currently available in the market, such as mobile phones, tablet PCs, automotive electronic products, are normally equipped with multimedia playing function. However, along with the quick and mass generation of multimedia files, the conventional operation procedures for playing multimedia files, such as photos, music, and films, on electronic devices by using file listing method are very complicated.

Referring to FIG. 1, a schematic diagram illustrating a directory structure of files according to a generally known technology is shown. In FIG. 1, root directory of the storage device is assumed to contain three jpg files (dog1.jpg, do2.jpg, and dog3.jpg) and two sub-directories (directories “A” and “B”).

The directory “A” further contains four jpg files (Photo1.jpg, Photo2.jpg, Photo3.jpg and Photo4.jpg) and two sub-directories (directories “A1” and “A2”). The directory “A1” merely contains a directory “a”. The directory “A2” does not contain any multimedia files nor directories.

Moreover, the directory “a” further contains three sub-directories (directories “aa”, “bb”, and “cc”). The directory “a” further contains a jpg file (play1.jpg) and three mp3 files (song1.mp3, song2.mgp and song3.mp3). The directories “bb” and “cc” do not contain any multimedia files nor sub-directories.

The directory “B” further contains three sub-directories (directories “B1” “B2”, and “B3”).

The directory “B1” contains an Animal.wav file and a directory “a”. The directory “a” contains a sub-directory “aa”. Moreover, the directory “aa” contains seven jpg files (game1.jpg, game2.jpg, game3.jpg, game4.jpg, game5.jpg, game6.jpg, and game7.jpg).

The directory B2 contains three mp3 files (Music1.mp3, Music2.mp3, and Music3.mp3).

The directory B3 contains a sub-directory “a”, which contains two files (Travel1.mpg and Travel2.mpg).

Presumably, when the directory structure of FIG. 1 is adopted, many steps are required for selecting a desired multimedia file on an electronic device. For convenience of descriptions, it is assumed that the user desires to select file Travel1.mpg. Thus, the file Travel1.mpg as shown in FIG. 1 is circled.

Referring to FIG. 2A, a schematic diagram illustrating a root directory of FIG. 1 is shown. When the user turns on power of the electronic device or installs a memory card in the electronic device, a root directory “root” is firstly displayed. Then, the user selects the root directory with control of cursor or through a touch operation.

After the user selects the root directory, the electronic device displays two sub-directories (directories “A” and “B”) under the root directory for the user to select.

FIG. 2B is a schematic diagram illustrating how a user selects the directory “B” under the root directory as shown in the directory structure of FIG. 1. The root directory contains directories “A” and “B”. Then, the user again selects the directory “B” with the control of cursor or through the touch operation. Then, the three sub-directories (directories “B1”, “B2”, and “B3”) contained in the directory “B” are displayed.

FIG. 2C is a schematic diagram illustrating how the directories “B1”, “B2”, and “B3” under the user-selected directory B are provided for the user to select as shown in the directory structure of FIG. 1. As indicated in FIG. 2C, the directories “B1”, “B2”, and “B3” contained in the directory “B” are displayed if the directory “B” is selected. Similarly, the user selects the directory “B3” with the control of cursor or through the touch operation. Then, the multimedia files contained in the directory “B3” are displayed.

Referring to FIG. 2D, a schematic diagram illustrating the plurality of multimedia files contained in the user-selected directory B3 as shown in the directory structure of FIG. 1 is shown. Not until now will the user be able to select the desired file “Travel2.mpg”.

The directory structure of FIG. 1 is not complicated. However, when the user would like to select a multimedia file from a multi-layered directory structure, the user has to repeatedly selecting directories and files. If the user knows exactly which file (e.g, Travel.mpg) to play but forgets the correct storage path of the desired file (i.e. root/B/B3/a/Travel.mpg), the whole selecting process will become even more complicated.

Moreover, the multimedia files played by the electronic device may be provided by an internal memory or an external storage device (such as a memory card or a USB device). Given that the storage devices from different sources, and each storage device has its respective directory structure, the process for selecting files from such directory structure will become even more complicated.

It can be known from the above descriptions that the conventional technology recursively selects multimedia files via a layer-by-layer scheme. Such approach is meandering, circuitous, and unpractical. Thus, how to provide a convenient directory selection operation taken in conjunction with the multimedia playing function of the electronic device has become a prominent task.

### SUMMARY OF THE INVENTION

According to one embodiment of the present invention, a display method applied to an electronic device is provided. The display method includes steps of: searching storage positions of a plurality of multimedia files in a storage device so as to retrieve a plurality of storage path strings corresponding to the plurality of multimedia files; parsing the plurality of storage path strings and consequently retrieving at least one simplified path corresponding to the plurality of multimedia files; displaying the at least one simplified path; selecting one of the at least one simplified path according to a directory selection operation; displaying at least one multimedia file corresponding to the at least one simplified path being selected.

According to another embodiment of the present invention, an electronic device is provided. The electronic device includes a non-volatile storage module, a control module, a parsing module, a display module, and an input module. The non-volatile storage module stores a plurality of multimedia files. The control module is electrically connected to the storage module for searching storage positions of the plurality of multimedia files in the non-volatile storage module so as to retrieve a plurality of storage path strings corresponding to the plurality of multimedia files. The parsing module is electrically connected to the control module for parsing the plurality of storage path strings and consequently retrieving at least one simplified path corresponding to the plurality of multimedia files. The display module is electrically connected to the parsing module for displaying the at least one simplified path. The input module senses a directory selection operation. The control module selects one of the at least one simplified path according to the directory selection operation and controls the display module to display at least one multimedia file corresponding to the at least one simplified path being selected.

According to an alternate embodiment of the present invention, a multimedia system is provided. The multimedia system includes a storage device, and an electronic device. The storage device stores a plurality of multimedia files. The electronic device includes a read module, a control module, a parsing module, a display module, and an input module. The read module accesses the storage device. The control module is electrically connected to the read module for searching storage positions of the plurality of multimedia files in the storage device through the read module so as to retrieve a plurality of storage path strings corresponding to the plurality of multimedia files. The parsing module is electrically connected to the control module for parsing the plurality of storage path strings and consequently retrieving at least one simplified path corresponding to the plurality of multimedia files. The display module is electrically connected to the parsing module for displaying the at least one simplified path. The input module is electrically connected to the control module for transmitting a directory selection operation obtained by sensing to the control module. The control module selects one of the at least one simplified path according to the directory selection operation and consequently controls the display module to display at least one multimedia file corresponding to the at least one simplified path being selected.

According to another alternate embodiment of the present invention, a computer program product equipped with a software program is provided. When the software program is executed, the software program performs a display method on an electronic device having a controller. The display method includes steps of: searching storage positions of a plurality of multimedia files in a storage device so as to retrieve a plurality of storage path strings corresponding to the plurality of multimedia files; parsing the plurality of storage path strings and consequently retrieving at least one simplified path corresponding to the plurality of multimedia files; displaying the at least one simplified path; selecting one of the at least one simplified path according to a directory selection operation; and displaying at least one multimedia file corresponding to the at least one simplified path being selected.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) is a schematic diagram illustrating a directory structure of files according to a generally known technology;

FIG. 2A (prior art) is a schematic diagram illustrating a root directory as shown in the directory structure of FIG. 1;

FIG. 2B (prior art) is a schematic diagram illustrating how a user selects the directory B under the root directory;

FIG. 2C (prior art) is a schematic diagram illustrating how the directories B1, B2, and B3 under the user-selected directory B are provided for the user to select;

FIG. 2D (prior art) is a schematic diagram illustrating the plurality of multimedia files contained in the user-selected directory B3 as shown in the directory structure of FIG. 1;

FIG. 3 is a schematic diagram illustrating how the positions of the multimedia files are retrieved after searching storage positions of the multimedia files according to an embodiment of the present invention;

FIG. 4 is a correspondence list of names representing simplified paths and multimedia files retrieved by parsing according to an embodiment of the present invention;

FIG. 5A is a schematic diagram illustrating a simplified path displayed by an electronic device according to an embodiment of the present invention;

FIG. 5B is a schematic diagram illustrating the directory content after the directory a of FIG. 5A is selected according to an architecture of simplified path of the present invention;

FIG. 6A is a schematic diagram illustrating an electronic device providing only simplified paths corresponding to audio type multimedia files;

FIG. 6B is a schematic diagram illustrating an electronic device providing simplified paths corresponding to audio files;

FIG. 7 is a schematic diagram of obtaining correspondence relationships between storage paths, simplified paths, and multimedia files according to a display method of the present invention;

FIGS. 8A and 8B are a display flowchart applied to the electronic device according to an embodiment of the present invention;

FIG. 9 is a block diagram illustrating how multimedia files are read from a built-in storage device by an electronic device according to an embodiment of the present invention; and,

FIG. 10 is a block diagram of a multimedia system according to an embodiment of the present invention.

### DETAILED DESCRIPTION OF THE INVENTION

The present invention improves procedures for displaying and selecting directories. Electronic device using the display method of the present invention can largely reduce process time and procedures required for selecting multimedia files. For convenience of descriptions, it is assumed that the electronic device exemplified in the embodiments below adopts Android operating system, but the application of the present invention is not limited thereto. Similar approaches taken in conjunction with different programs and functions can be implemented in other operating systems.

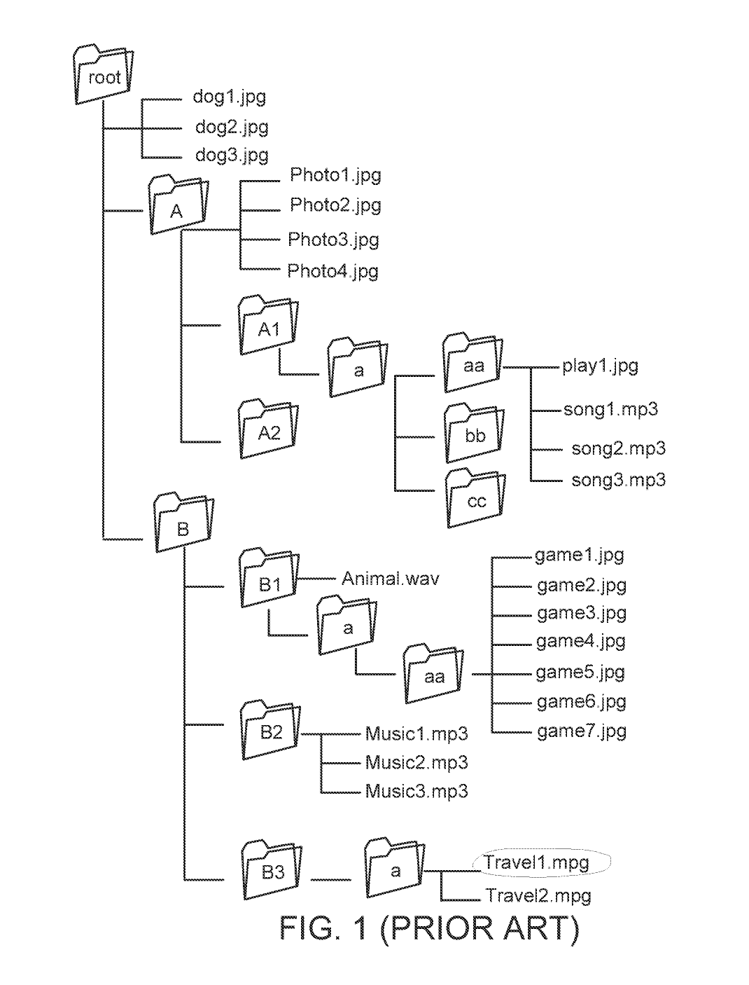

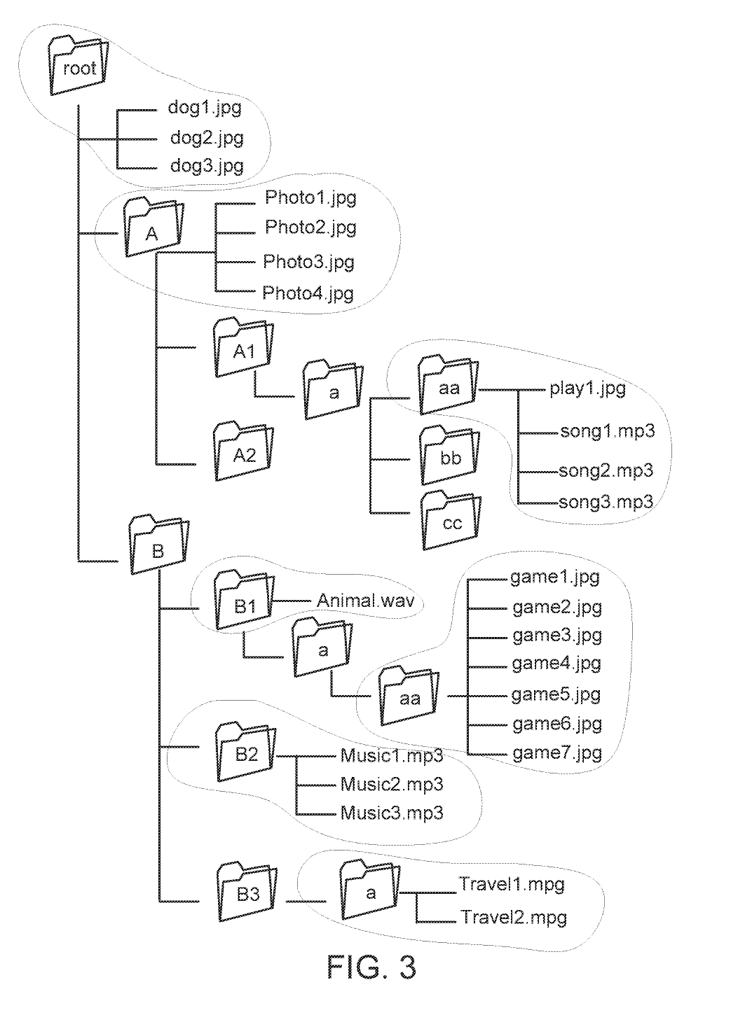

FIG. 3 is a schematic diagram illustrating how the positions of the plurality of multimedia files are retrieved after searching storage positions of the plurality of multimedia files according to an embodiment of the present invention. For convenience of comparison, it is assumed that disposition of files stored in the electronic device is similar to that as shown in FIG. 1.

Firstly, based on MediaScanner function, all multimedia files stored in the storage device are completely checked so as to retrieve storage positions of all the multimedia files in the storage device. That is, whether any multimedia files or sub-directories are contained under each layer of directories is determined. If a directory contains any multimedia file, the storage path of the multimedia file can be correspondingly retrieved. If the directory further contains a sub-directory, then whether the sub-directory contains any multimedia files can be verified through recursive retrieval or other approaches.

The directories in each layer between the root directory and the storage position of a multimedia file are referred as storage path of the multimedia file. The multimedia files may be stored under the root directory or under the directories (sub-directories) at different layers.

The multimedia files may be stored under the roor directory or sub-directories. The storage paths of some multimedia files are exemplified below for description purpose.

The multimedia files stored under the root directory are exemplified below.

root/dog1.jpg
root/dog2.jpg

Under the sub-directories of the root directory, the multimedia files stored are exemplified below.

root/A/Photo1.jpg
root/A/A1/a/aa/play1.jpg
root/A/A1/a/aa/song1.mp3
root/A/A1/a/aa/song2.mp3
root/A/A1/a/aa/song3.mp3

Similarly, the storage paths of the remaining multimedia files can be retrieved by analogy, but are not exemplified here. Then, storage path strings representing the storage paths can be retrieved by using GetAllMediaFilePath function. The storage path strings represent absolute paths of the multimedia files. The absolute paths includes names of directories at each layer between the root directory of the storage device and the directory containing the multimedia files.

Afterwards, simplified paths corresponding to the multimedia files are retrieved. In short, the storage path strings are parsed; and, only part of the storage path strings are reserved and considered as the simplified paths.

FIG. 3 illustrates the simplified paths of directory structure according to an embodiment of the present invention. In the present embodiment, no matter the multimedia files are at the same layer of the directory structure or not, only the names of the directories containing the multimedia files are retrieved and used as the simplified path.

For instance, the three files dog1.jpg, dog2.jpg, and dog3.jpg are stored under the root directory. Thus, the storage path string of the three files dog1.jpg, dog2.jpg, and dog3.jpg are identical as “root/”, and the simplified path of these three files is “root/” as well.

The four files Photo1.jpg, Photo2.jpg, Photo3.jpg and Photo4.jpg are stored under the directory “A” contained in the root directory. Thus, the storage path string of these four files is “root/A/”, but the simplified path of these four files is “A/”.

The four files, play1.jpg, son1.mp3, song2.mp3 and song3.mp3, are stored under the sub-directory “aa” of the directory “a”, wherein the directory “a” is further contained in the sub-directory “A1” of the directory “A”. Thus, the storage path string of these four files is “root/A/A1/a/aa”, and the simplified path of these four files is “aa/”.

Similarly, the storage path string of the file “Animal.wav” is “root/B/B1/”, and the simplified path of that is “B1/”. The storage path strings of the files game1.jpg to game7.jpg are “root/B/B1/a/aa/”, and the simplified path of these files are “aa/”. The storage path strings of the files Music1.mp3, Music2.mp3, and Music3.mp3 are “root/B/B2/”, and the simplified path of these files is “B2/”. The storage path string of the files Travel1.mpg and Travel2.mpg is “root/B/B3/a/”, and the simplified path of these files is “a/”.

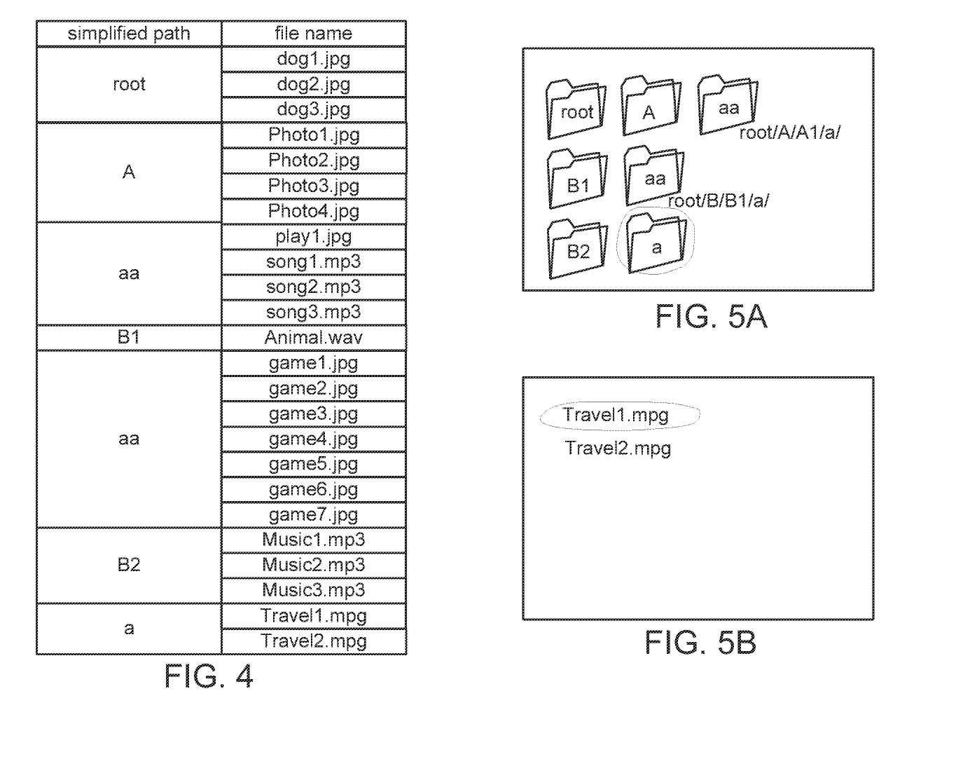

FIG. 4 is a correspondence list of names representing simplified paths and multimedia files retrieved by parsing according to an embodiment of the present invention.

The first column of FIG. 4 represents simplified path (name of directory), and the second column represents name of the multimedia files. Since the directory may contain several multimedia files, different multimedia files may correspond to the same simplified path.

As indicated in FIG. 4, both the simplified path of the fourth row and that of the sixth row are designated by “aa/”. However, these two simplified paths actually correspond to different directories.

The simplified path “aa/” of the fourth row represents storage path string of “root/A/A1/a/aa/”, and the simplified path “aa/” of the sixth row represents storage path string of “root/B/B1/a/aa”.

With respect to the above case in which the same simplified path corresponds to different storage path strings, the simplified paths are differentiated according to attributes such as creator name, setup time, storage path string, and ID3 information of the MP3 music of the directory, or any other attributes capable of differentiating directories.

As summarized in FIG. 4, the electronic device will obtain seven simplified paths, namely, the directory “root”, the directory “A”, the directory “aa”, the directory “B1”, the directory “aa”, the directory “B2”, and the directory “a”.

Referring to FIG. 5A, a schematic diagram illustrating a simplified path displayed by an electronic device according to an embodiment of the present invention is shown.

Based on the concept of the present invention, when the electronic device is booted or loaded with a memory card, all multimedia files stored in the storage device are searched through the GetAllMediaFilePath function. After the storage path strings of all multimedia files are retrieved, the storage path strings are consequentially parsed so as to retrieve simplified path corresponding to the multimedia files. The multimedia files are then displayed in the form of the simplified paths.

The simplified paths representing the seven directories disclosed above are displayed in FIG. 5A. Since two directories have the same simplified path (aa), relevant attributes of the two directories are further displayed. Here, it is assumed that the displayed attribute is storage path string.

After the user sees the display panel as shown in FIG. 5A, the user selects the simplified path “a/” according to a directory selection operation. The simplified path “a/” actually represents storage path string of “root/B/B3/a”.

FIG. 5B is a schematic diagram illustrating the directory content after the directory “a” of FIG. 5A is selected. After the user selects the directory “a” according to the directory selection operation, the electronic device displays the two multimedia files contained in the directory “a”, i.e. Travel1.mpg and Travel2.mpg. Meanwhile, the user further selects the “Travel1.mpg” file with a file selection operation.

According to the present invention, if Travel1.mpg file is selected, the user only needs to perform the directory selection operation once and the file selection operation once.

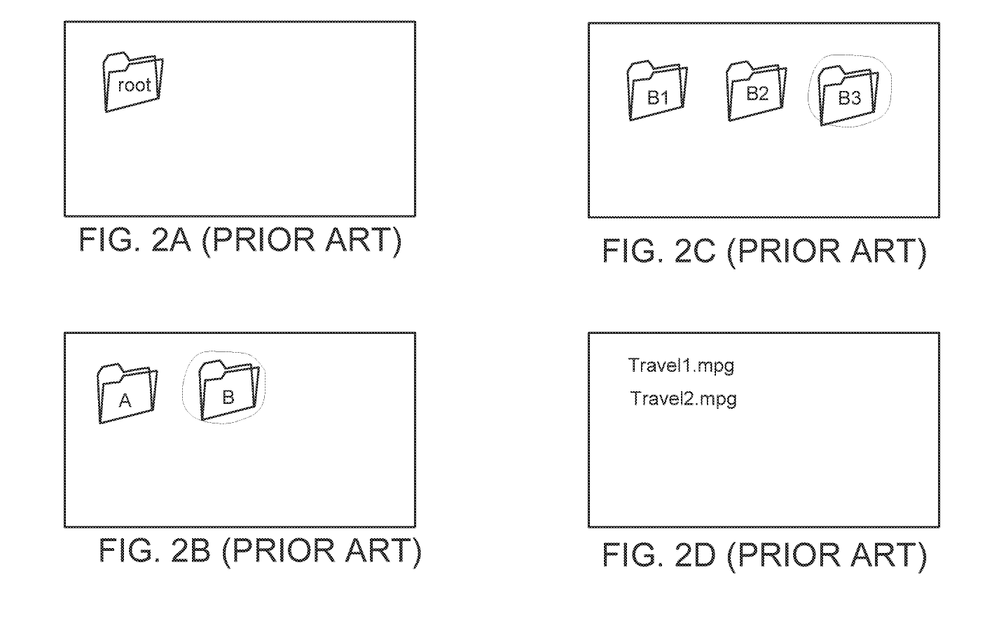

A comparison between FIGS. 2A to 2D and FIGS. 4A to 4B shows that when the present invention is adopted, the electronic device provides a more convenient file selection operation.“Travel1.mpg” file which was retrieved through several times of selection operation can now be retrieved through only two times of selection operation. If the directory structure of the storage device has many layers, the simplified selection operation can make the selection process even more convenient.

Given that the above approach is adopted, the user can quickly find out whether the user selects a wrong simplified path in the first place and re-select a correct simplified path even though.

In practical application, format of simplified path is not subjected to particular restrictions. For instance, the user can set the directory at the bottommost layer as simplified path, or display the two bottommost layers of directories as simplified path.

Or, the format of the simplified path displayed by the electronic device can be defined according to the user's habits of use. For instance, if the user A prefers to listen to audio files when using a mobile phone, the mobile phone of the user A can set the directories containing music files as simplified path so as to simplify the operation procedure.

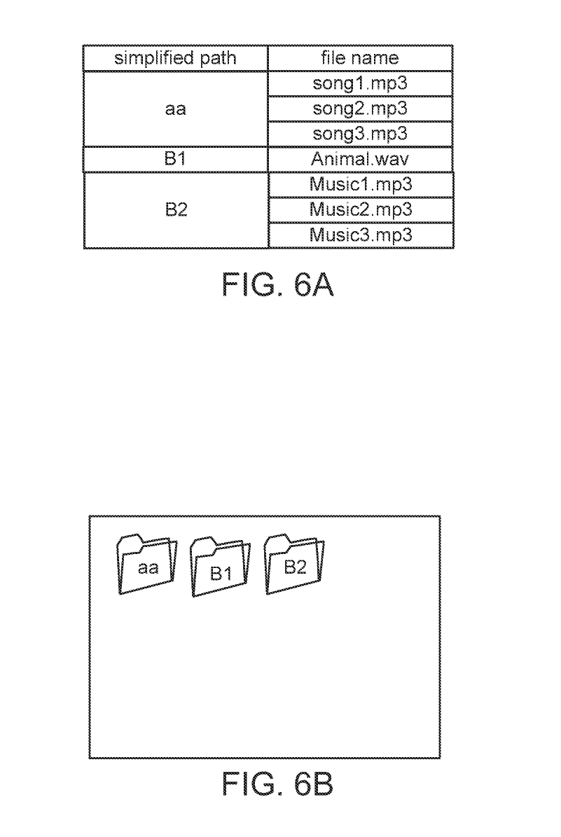

Referring to FIG. 6A, a schematic diagram illustrating an electronic device providing only simplified paths corresponding to audio type multimedia files is shown. FIG. 6B assumes that the electronic device deletes the non-audio files off the retrieved multimedia files. Thus, only seven audio files (song1.mp3, song2.mp3, sond3.mp3, Animal.wav, Music1.mp3, Music2.mp3, and Music3.mp3) are retrieved according to the directory structure of FIG. 1. Then, storage paths of the audio files are parsed so as to retrieve a correspondence table as shown in FIG. 6A.

In fact, the directory “aa” corresponding to the files song1.mp3, song2.mp3, and song3.mp3 also contains a video file “play1.jpg”. However, the video “play1.jpg” file not will not be displayed even if the user clicks on the simplified path “aa/”.

Referring to FIG. 6B, a schematic diagram illustrating an electronic device providing simplified paths corresponding to audio files only is shown. Based on FIG. 6A, FIG. 6B displays only directories “aa, B1 and B2”.

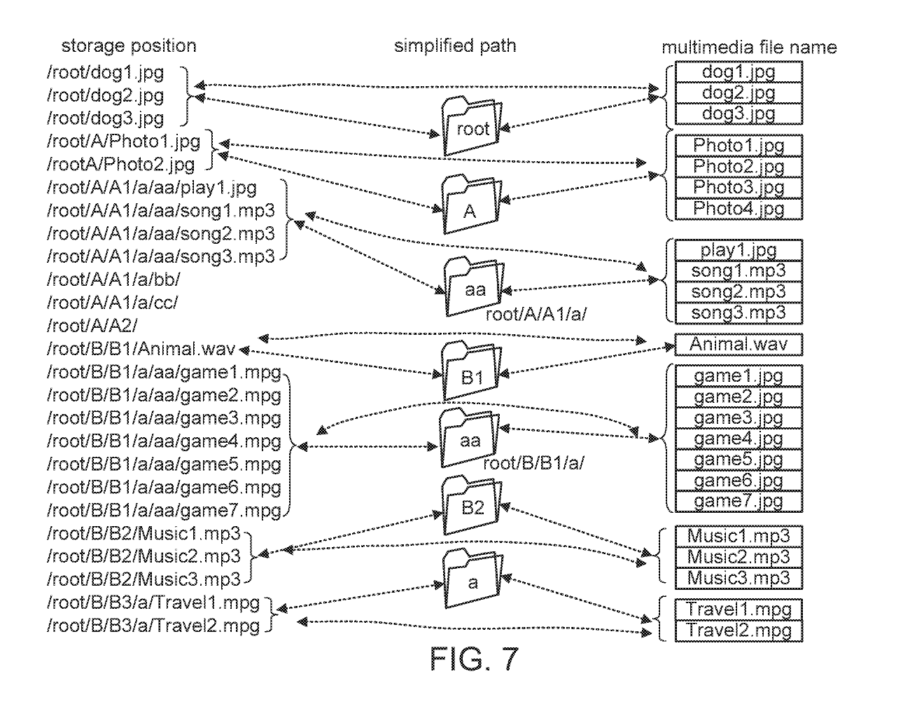

Referring to FIG. 7, a schematic diagram of obtaining correspondence relationships between storage paths, simplified paths, and multimedia files according to a display method of the present invention is shown.

Based on the concept of the present invention, the electronic device, further parses the storage path strings so as to retrieve names of directories from the storage path strings after retrieving the storage path strings of all multimedia files. The names of directories represent the directories containing the multimedia files at the bottommost layer.

Then, as indicated in FIG. 7, the correspondence relationships between the multimedia files, names of directories and the storage path strings are established. The names of directories are hence used as simplified paths.

As indicated in FIG. 7, multimedia files with identical storage path strings are corresponding to a same simplified path. Moreover, each simplified path further corresponds to one/some multimedia file(s).

For instance, the storage path string of the file “dog1.jpg” is “root/”, and the simplified path corresponding to the storage path string of the file “dog1.jpg” is “root”. The simplified path represents root directory “root” under which three files, dog1.jpg, dog2.jpg, and dog3.jpg, are contained.

When the user boots the electronic device or installs a memory card in the electronic device, the seven simplified paths are first retrieved. Given that the user selects a simplified path “B1”, the name of directory being selected is “B1” as well. Then, the electronic device displays at least one candidate multimedia file stored under the selected name of directory (B1). Since the directory B1 merely contains file “Animal.wav”, the electronic device will start playing the file Animal.wav selected by the user.

Similarly, the present invention also provides similar operation mode for other multimedia files stored in the electronic device. For instance, the user makes judgment according to attributes of “root/A/A1/a/” and selects the third simplified path counting down from the top of FIG. 7. Then, the electronic device correspondingly displays the multimedia files (play1.jpg, song1.mp3, song2.mp3, and song3.mp3) contained in the directory “aa”. Then, the user again selects and at least one multimedia file for playing.

When displaying a directory representing simplified path, icon of multimedia file can be used to represent the directory containing the multimedia file. For instance, when the multimedia file contains a graphic file, the graphic file can be used as the icon of the directory. When the multimedia file contains audio/video files, image segment of audio/video bitstream can be used as the icon of the directory. When the multimedia file contains an audio file, information corresponding to the audio file such as album titles and singer names is displayed.

Representation of directories corresponding to the simplified paths can be adjusted or modified by anyone who is skilled in the technology field of the present invention, and variations of the said representation are not elaborated here.

Moreover, in practical application, if different directories have similar storage paths, similar strings can be omitted when recording the storage paths. For example, in the said directory structure, directories B1, B2, and B3 are positioned at a layer under the directory B.

Thus, the portion “/root/B/” is the similar storage path of the directories B1, B2, and B3. This portion of storage path does not need to be stored with respect to the directories B1, B2, and B3 respectively. Hence, efficiency in the use of storage space is improved.

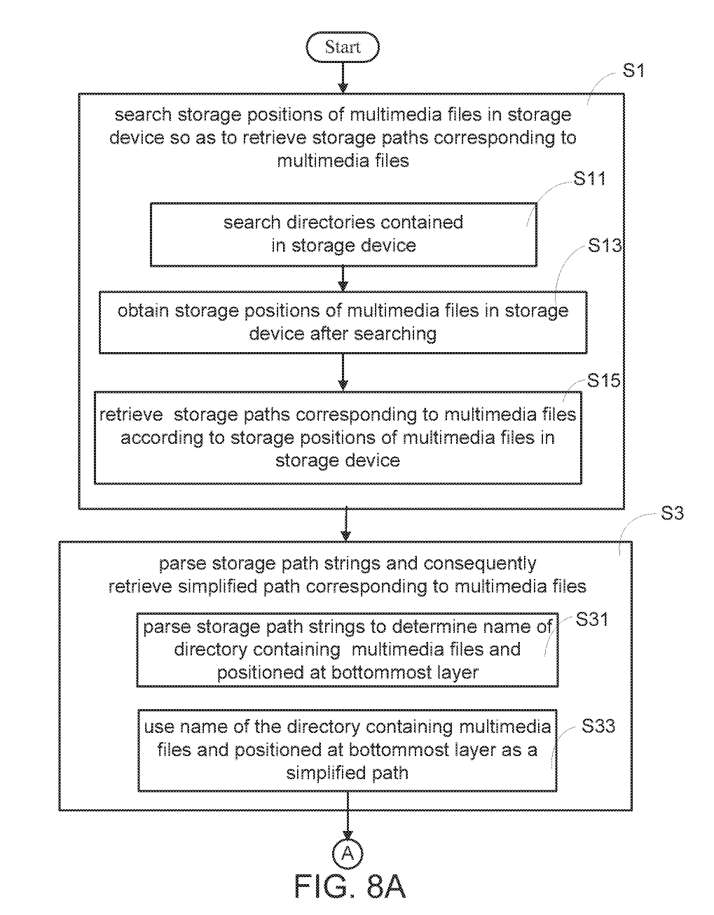

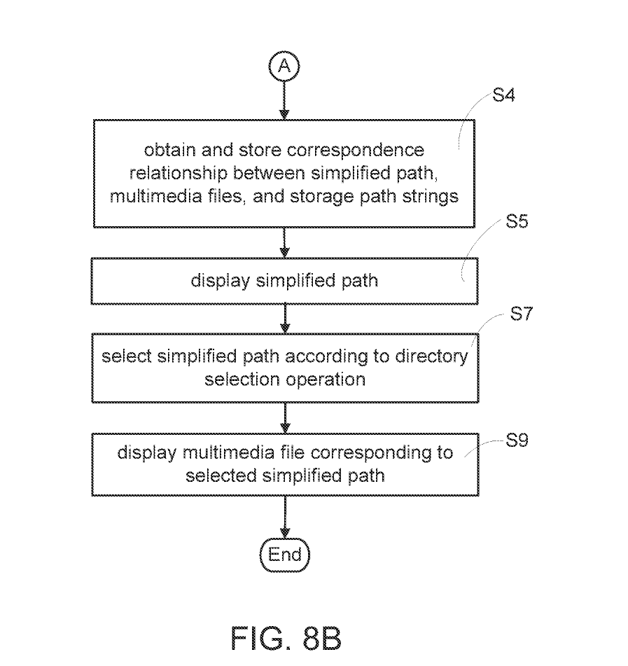

Referring to FIGS. 8A and 8B, a display flowchart applied to the electronic device according to an embodiment of the present invention is shown. To summarize the above descriptions, the display method of the present invention includes the steps disclosed below.

Firstly, the storage positions of the multimedia files in the storage device are searched. The storage path strings corresponding to the multimedia files are consequently retrieved (step S1). Next, the storage path strings are parsed and simplified path corresponding to the multimedia files is consequently retrieved (step S3). Correspondence relationships between the simplified paths, the multimedia files, and the storage path strings are obtained and stored (step S4). The at least one simplified path is displayed (step S5). A simplified path is selected according to a directory selection operation (step S7). The multimedia files corresponding to the simplified path being selected are displayed (step S9).

Step S1 further includes the following steps. Directories contained in the storage device are searched (step S11). The storage positions of the multimedia files in the storage device are obtained after searching (step S13). The storage path strings corresponding to the multimedia files are retrieved according to the storage positions of the multimedia files in the storage device (step S15).

The purpose for searching the directories of the storage device is to retrieve the storage path strings corresponding to the multimedia files, and searching method is not limited to any particular approaches. For instance, the searching method can be implemented by using recursive searching method, sequential searching method or other searching methods.

Step S3 further includes the following steps. The storage path strings are parsed to determine names of directories of bottommost directories containing the plurality of multimedia files (step S31). The names of the bottommost directories containing the multimedia files are used as the simplified paths (step S33).

When the names of the directories are identical, the display method of the present invention further displays attributes associated with the directories. Examples of the attributes are such as but not limited to storage path strings, creator, setup time, content information, and storage file types of the directories etc.

According to the present invention, the origins of multimedia files may be a built-in storage device, a non-volatile storage module or other sources.

Also, the multimedia files may be provided by an external memory card, or an external storage device connected through a USB. These external storage devices can be electrically connected to the electronic device in a detachable manner, and the electronic device can access the multimedia files stored in the storage device through a read module.

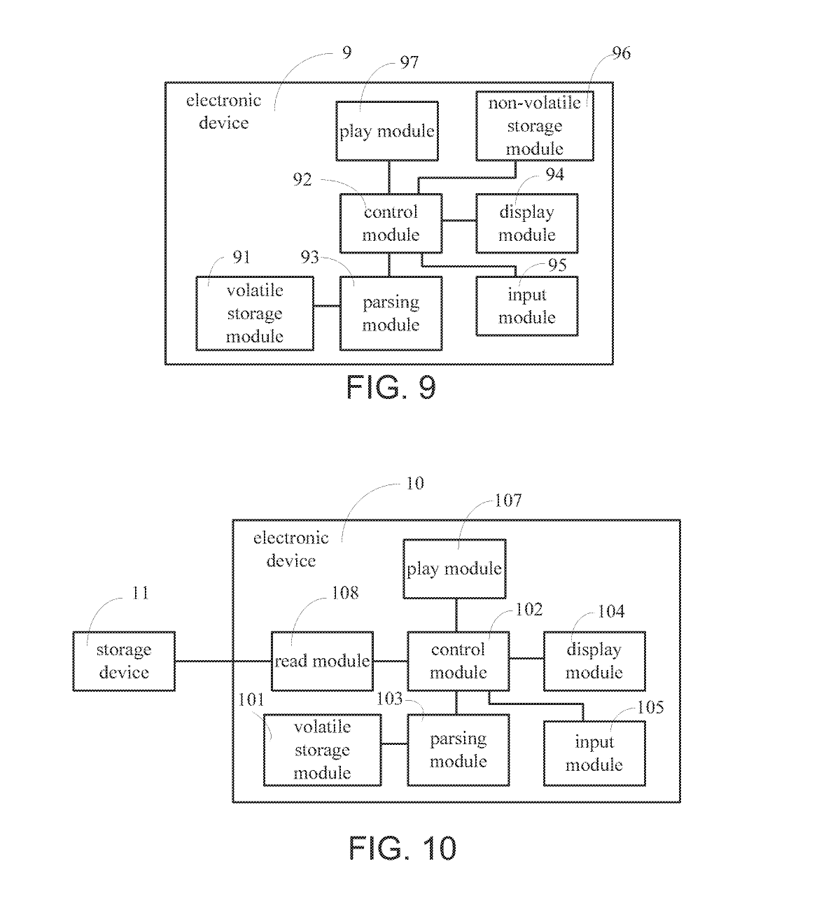

Referring to FIG. 9, a block diagram illustrating how multimedia files are read from a built-in storage device by an electronic device according to an embodiment of the present invention is shown. The electronic device 9 of the present invention includes a volatile storage module 91, a control module 92, a parsing module 93, a display module 94, an input module 95, a non-volatile storage module 96, and a play module 97. The control module 92 is electrically connected to other modules.

The non-volatile storage module 96 used for storing multimedia files can be a flash memory or other types of memory devices. The file system of the memory device is not limited to particular restrictions.

When the electronic device is booted, the control module 92 searches storage positions of the multimedia files in the non-volatile storage module 96 so as to retrieve the storage path strings corresponding to the multimedia files. The control module 92 searches directories contained in the non-volatile storage module. The storage path strings corresponding to the multimedia files can be retrieved after the storage positions of the multimedia files in the non-volatile storage module 96 are obtained.

After obtaining the correspondence relationships between the simplified path, the multimedia files, and the storage path strings, the control module 92 stores the correspondence relationships in the volatile storage module 91.

Besides, the parsing module 93 parses the storage path strings retrieved by the control module 92 and consequently retrieves the simplified path corresponding to the multimedia files.

The display module 94 displays at least one simplified path and multimedia data (such as images and video strings) decoded by the play module.

After the input module 95 senses a directory selection operation, the control module 92 selects one or some of the at least one simplified path according to the directory selection operation and controls the display module 94 to display one or more than one multimedia file corresponding to the simplified path(s) being selected.

Then, the input module 95 transmits a file selection operation obtained by way of sensing to the control module 92. After the control module 92 selects the plurality of multimedia files through the read module, the play module 97 plays the multimedia files being selected. The play module 97 may be a video play module or an audio play module.

Referring to FIG. 10, a block diagram of a multimedia system according to an embodiment of the present invention is shown. The multimedia system of the present invention includes a storage device 11 and an electronic device 10. The operations of the control module 102, the parsing module 103, the display module 104, the input module 105, and the play module 107 of the electronic device 10 are similar to corresponding ones as shown in FIG. 9, and the similarities are not repeated.

In comparison to the electronic device of FIG. 9, the electronic device of FIG. 10 is taken in conjunction with an external storage device 11. Thus, the electronic device 10 retrieves the multimedia files stored in the storage device 11 through the read module 108.

Since the storage device 11 can be an external memory card or a hard disc connected through a USB, the storage device 11 can be dynamically replaced. Thus, as well as searching multimedia files when the electronic device 10 is booted, the control module 102 further searches the storage positions of the multimedia files when the storage device 11 is plugged or replaced.

The present invention can combine the function of the electronic device of FIG. 9 with that of FIG. 10. Thus, the electronic device includes a non-volatile storage module storing multimedia files, and is capable of retrieving multimedia files from the storage device through the read module. Moreover, the number of storage devices electrically connected to the electronic device can be plural. Anyone who is skilled in the technology field of the present invention can make necessary modification or adjustment, and the details are not repeated here.

The present invention can also be applied to other types of computer program products. When the software programs stored in the computer program product are executed, the electronic device equipped with a controller can perform the display method as shown in FIGS. 8A and 8B.

When the display method of the present invention is applied to a multiplex electronic device, the display method can be implemented by a service or a task of the operating system. Or, when the electronic device operates at a simplex mode, the display method of the present invention can be implemented through polling.

In other words, the implementation of the present invention is very flexible. Any approaches are within the scope of protection of the present invention as long as all storage paths of the plurality of multimedia files are searched, the retrieved simplified paths are parsed, and the multimedia files are accessed according to correspondence relationships between the simplified path and the multimedia files.

It should also be noted that the electronic device may write correspondence relationships between the multimedia files, the storage path and the simplified path as well as information associated with the multimedia files to a particular reference file or a reference directory. By doing so, subsequent processing can be expedited.

The use of input device is more convenient in a PC than in an ordinary portable product. When the method of the present invention is adopted, the user's inconvenience of selecting files on the small display screen of the portable product would be largely reduced.

In terms of the application of vehicle electronics, when driving a vehicle, the user can dynamically select files and consequentially play the selected files in a more efficient manner. By doing so, the user will be less distracted with operations of vehicle electronics.

As disclosed above, through the file listing function provided by the operating system of the electronic device of the present invention, multimedia files can be selected and played in a more convenient manner. According to the method of the present invention, directory structure of storage device can be quickly retrieved, and no complicated computation is required.

While the invention has been described through example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display method, applied to an electronic device, comprising steps of:
searching storage positions of a plurality of multimedia files in a storage device so as to retrieve a plurality of storage path strings corresponding to the plurality of multimedia files;
parsing the plurality of storage path strings and consequently retrieving at least one simplified path corresponding to the plurality of multimedia files;
displaying the at least one simplified path;
selecting one of the at least one simplified path according to a directory selection operation; and
displaying at least one multimedia file corresponding to the at least one simplified path being selected.

2. The display method according to claim 1, further comprising steps of:
obtaining correspondence relationships between the at least one simplified path, the plurality of multimedia files, and the plurality of storage path strings.

3. The display method according to claim 2, further comprising step of:
storing the correspondence relationships between the at least one simplified path, the plurality of multimedia files, and the plurality of storage path strings.

4. The display method according to claim 1, wherein the step of searching the storage positions of the plurality of multimedia files in the storage device so as to retrieve the plurality of storage path strings corresponding to the plurality of multimedia files comprises steps of:
searching a plurality of directories contained in the storage device;
obtaining the storage positions of the plurality of multimedia files in the storage device after searching; and
retrieving the plurality of storage path strings corresponding to the plurality of multimedia files according to the storage positions of the plurality of multimedia files in the storage device.

5. The display method according to claim 1, wherein the plurality of storage path strings correspond to absolute paths of the plurality of multimedia files, and the absolute paths comprise names of directories at each layer between a root directory of the storage device and directories containing the plurality of multimedia files.

6. The display method according to claim 1, wherein
the plurality of simplified paths are names of the directories containing the plurality of multimedia files.

7. The display method according to claim 6, wherein when a first multimedia file is positioned under a root directory of the storage device, simplified path corresponding to the first multimedia file is name of the root directory.

8. The display method according to claim 6, wherein when a second multimedia file is positioned under a sub-directory of the storage device, simplified path corresponding to the second multimedia file is name of the sub-directory.

9. The display method according to claim 1, wherein the step of parsing the plurality of storage path strings and consequently retrieving the at least one simplified path corresponding to the plurality of multimedia files comprises steps of:
parsing the plurality of storage path strings to determine names of bottommost directories containing the plurality of multimedia files; and
using the names of the bottommost directories containing the plurality of multimedia files as the plurality of simplified paths.

10. The display method according to claim 9, wherein when a name of a first directory and a name of a second directory are identical, the play method further comprises step of:
displaying attributes associated with the first directory and the second directory.

11. The display method according to claim 10, wherein the attributes associated with the first directory and the second directory are storage path strings, creator, setup time, content information, or storage file types of the first and the second directories.

12. The display method according to claim 1, wherein the storage device is built-in in the electronic device or is electrically connected to a read module of the electronic device in a moveable manner.

13. An electronic device, comprising:
a non-volatile storage module, for storing a plurality of multimedia files;
a control module, electrically connected to the non-volatile storage module, for searching storage positions of the plurality of multimedia files in the non-volatile storage module so as to retrieve a plurality of storage path strings corresponding to the plurality of multimedia files;
a parsing module, electrically connected to the control module, for parsing the plurality of storage path strings and consequently retrieving at least one simplified path corresponding to the plurality of multimedia files;
a display module, electrically connected to the parsing module, for displaying the at least one simplified path; and
an input module, for sensing a directory selection operation, wherein the control module selects one of the at least one simplified path according to the directory selection operation and controls the display module to display at least one multimedia file corresponding to the at least one simplified path being selected.

14. The electronic device according to claim 13, wherein the control module obtains correspondence relationships between the at least one simplified path, the plurality of multimedia files, and the plurality of storage path strings.

15. The electronic device according to claim 14, further comprising:
a volatile storage module, electrically connected to the control module, for storing the correspondence relationships between the at least one simplified path, the plurality of multimedia files, and the plurality of storage path strings.

16. The electronic device according to claim 13, wherein the control module searches a plurality of directories contained in the non-volatile storage module so as to obtain the storage positions of the plurality of multimedia files in the non-volatile storage module after searching, and consequently retrieves the plurality of storage path strings corresponding to the plurality of multimedia files.

17. The electronic device according to claim 13, wherein the plurality of storage path strings correspond to absolute paths of the plurality of multimedia files, and the absolute paths comprise names of directories at each layer between a root directory of the storage device and directories containing the plurality of multimedia files.

18. The electronic device according to claim 13, wherein
the plurality of simplified paths are names of the directories containing the plurality of multimedia files.

19. The electronic device according to claim 18, wherein when a first multimedia file is positioned under a root directory of the non-volatile storage module, simplified path corresponding to the first multimedia file is name of the root directory.

20. The electronic device according to claim 18, wherein when a second multimedia file is positioned under a sub-directory of the non-volatile storage module, simplified path corresponding to the second multimedia file is name of the sub-directory.

21. The electronic device according to claim 13, wherein the parsing module parses the plurality of storage path strings to determine names of bottommost directories containing the plurality of multimedia files, and uses the names of the bottommost directories containing the plurality of multimedia files as the plurality of simplified paths.

22. The electronic device according to claim 21, wherein when a name of a first directory and a name of a second directory are identical, the control module controls the display module to display attributes associated with the first directory and the second directory.

23. The electronic device according to claim 22, wherein the attributes associated with the first directory and the second directory are storage path strings, creator, setup time, content information, and storage file types of the first and the second directories.

24. The electronic device according to claim 13, wherein the control module searches the storage positions of the plurality of multimedia files in the non-volatile storage module when the electronic device is booted.

25. A multimedia system, comprising:
a storage device, for storing a plurality of multimedia files;
an electronic device, comprising:
a read module, for accessing the storage device;
a control module, electrically connected to the read module, for searching storage positions of the plurality of multimedia files in the storage device through the read module so as to retrieve a plurality of storage path strings corresponding to the plurality of multimedia files;
a parsing module, electrically connected to the control module, for parsing the plurality of storage path strings and consequently retrieving at least one simplified path corresponding to the plurality of multimedia files;
a display module, electrically connected to the parsing module, for displaying the at least one simplified path; and
an input module, electrically connected to the control module, for transmitting a directory selection operation obtained by sensing to the control module, wherein the control module selects one of the at least one simplified path according to the directory selection operation and controls the display module to display at least one multimedia file corresponding to the at least one simplified path being selected.

26. The multimedia system according to claim 25, wherein the electronic device further comprises:
a play module, electrically connected to the control module, wherein the input module transmits a file selection operation obtained by sensing to the control module, and the control module selects one of the plurality of multimedia files through the read module and consequently controls the play module to play the multimedia file being selected.

27. The multimedia system according to claim 26, wherein the play module is a video play module or an audio play module.

28. The multimedia system according to claim 25, wherein the control module obtains correspondence relationships between the at least one simplified path, the plurality of multimedia files, and the plurality of storage path strings.

29. The multimedia system according to claim 28, further comprising:
a volatile storage module, electrically connected to the control module, for storing the correspondence relationships between the at least one simplified path, the plurality of multimedia files, and the plurality of storage path strings.

30. The electronic device according to claim 25, wherein the control module searches the storage positions of the plurality of multimedia files in the storage device when the electronic device is booted, and when the storage device in the electronic device is replaced.

31. A computer program product equipped with a software program, wherein when the software program is executed, the software program performs a display method on an electronic device having a controller, wherein the display method comprising steps of:
searching storage positions of a plurality of multimedia files in a storage device so as to retrieve a plurality of storage path strings corresponding to the plurality of multimedia files;
parsing the plurality of storage path strings and consequently retrieving at least one simplified path corresponding to the plurality of multimedia files;
displaying the at least one simplified path;
selecting one of the at least one simplified path according to a directory selection operation; and
displaying at least one multimedia file corresponding to the at least one simplified path being selected.
